(19) United States
(12) Patent Application Publication
(10) Pub. No.: US 2005/0133589 A1
(43) Pub. Date: Jun. 23, 2005

(54) Network connection apparatus

(75) Inventor: Chih-Chiang Chou, ChungHo City (TW)

Correspondence Address: TROXELL LAW OFFICE PLLC, Suite 1404, 5205 Leesburg Pike, Falls Church, VA, 22041, US

(73) Assignee: Chuang Guan Technology Co., Ltd.

(21) Appl. No.: 10/737,801

(22) Filed: Dec. 18, 2003

(51) Int. Cl. G06K 5/00

(52) U.S. Cl. 235/380

(57) ABSTRACT

An improved network connection apparatus that employs inherent functions of user identification cards such as identity authentication and encryption to achieve security functions. The user identification card is coupled with the network connection apparatus such as routers to prevent data from being stolen or disclosed. User identification cards also can be used to activate the network connection apparatus to enhance security of data transmission in networks. For the network connection apparatus that equip with encryption software, the user identification cards provide a double protection. The user identification card is a Subscriber Identity Module card (SIM card).

### BACKGROUND OF THE INVENTION

1. Field of the Invention

The present invention relates to an improved network connection apparatus that is activated by user identification cards and completes identity verification before accessing network and employs encryption function of the user identification cards to encrypt data before transmission to prevent data pilferage or disclosure.

2. Description of the Prior Art

With rapid advance of technology, information processing devices and communication related techniques are well developed today. They are widely used in every area. These days, the information processing devices can provide multiple functions. As the amount of information grows very rapidly, in order to improve enterprise competitiveness, every enterprise has to enhance its information processing equipment and peripheral devices to meet the modern system requirements. Meanwhile, security control and monitor also becomes a growing concern.

This is especially true for network communication systems that communicate with external environments. System security management is very important. Many small and mediate enterprises (SME) or personal workshops (SOHO) now use virtual private network (VPN) to transmit data. The purpose is to seek safety of data transmission. To establish VPN tunnel requires a lot of private data, such as Certificate of Authentication (CA), Preshare Key, employee ID (account number, identification), Password, or Private Network, etc. Hence how to prevent company internal data from being stolen or disclosed in very important.

Refer to FIG. 1 for the architecture of a conventional technique. It includes a network connection apparatus 1A which mainly consists of a memory device 11A, a transmission device 12A and a central processor 13A.

The memory device 11A can store basic setting data related to the network connection apparatus 1A and company confidential data and encryption software. The encryption software aims to protect company confidential data from being stolen or disclosed. The transmission device 12A includes an external connection device 121A and an internal connection device 122A to provide data output or input functions between an external network 14A and an internal network 15A. The external connection device 121A is a modem to connect the external network 14A. The internal connection device 122A is a connection port in the network. The internal connection device 122A may be coupled with a switch hub 16A to connect a plurality of connection ports in the network thereby to link a plurality of user ends to form the internal network 15A It also may be coupled with a wireless interface device 17A to connect to a signal transmission device 18A to link the user ends of the internal network 15A. The central processor 13A is electrically connected to the memory device 11A and transmission device 12A, and processes data in the memory device 11A and transmission device 12A to control data transmission in the network. Operation of the network connection apparatus 1A that adopts conventional techniques is depicted as follows:

When users want to read company confidential data stored in the memory device 11A or store company confidential data in the memory device 11A, first, user end has to connect to the transmission device 12A of the network connection apparatus 1A, then the central processor 13A calls the memory device 11A. If the memory device 11A has software of encryption function stored therein, the software sends back a data packet requesting the user to input access procedures, such as input password. After the software grants access, user can read and store data in the memory device 11A as desired.

However, vendors usually have pre-stored the basic settings of the VPN network connection apparatus 1A in the memory device 11A, such as Flash Read Only Memory (Flash ROM) or Compact Flash Card (CF card), and many companies also store the private and confidential data in the memory device 11A, although the memory device 11A has protection function provided by the encryption software resided therein, information stored in the Flash ROM, CF card or the like are easily accessed by other people through burners or card readers. And the encryption software is easily deciphered. Hence the security function in the conventional techniques is not sufficient. Vendors have tried to develop improved methods and means to prevent data from being stolen or disclosed.

### SUMMARY OF THE INVENTION

Therefore the present invention aims at providing an improved network connection apparatus that employs the inherent authentication and encryption capability of user identification cards to prevent data pilferage or disclosure, and using the primary setting data pre-stored in the user identification cards to enable users to use VPN easily by inserting the user identification cards into a network system without complex setting by the professionals.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the architecture of a conventional technique.

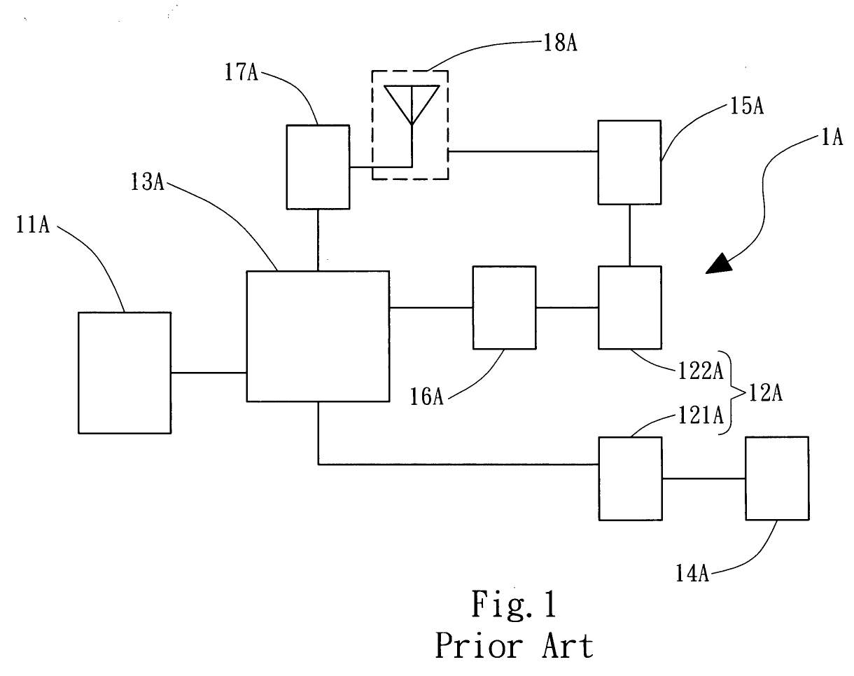

FIG. 2 is a block diagram of the architecture according to the invention.

### DESCRIPTION OF THE PREFERRED EMBODIMENT

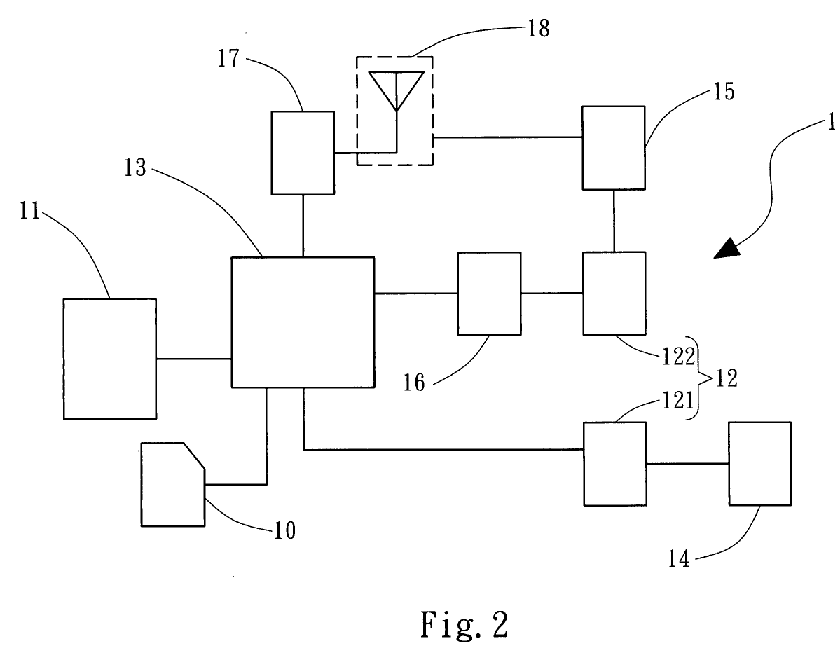

Refer to FIG. 2 for an architecture according to the present invention. The network connection apparatus 1 (such as a router) mainly includes an user identification card 10, a memory device 11, a transmission device 12 and a central processor 13.

The user identification card 10 is the main element to activate the network connection apparatus 1. The memory device 11 can store basic setting data related to the network connection apparatus 1. The transmission device 12 includes an external connection device 121 and an internal connection device 122 to provide data output or input functions between an external network 14 such as the Internet and an internal network 15 such as a Local Area Network (LAN) or a Wide Area Network (WAN). The central processor 13 is electrically connected to the user identification card 10, memory device 11 and transmission device 12, and processes data in the user identification card 10, memory device 11 and transmission device 12.

When an user end connects to the transmission device 12 through the external network 14 or internal network 15 to access the network, the user end transmits a data packet to the central processor 13 through the transmission device 12. The central processor 13 transfers to the user identification card 10. User identification card 10 receives the data packet and sends back another data packet through the original path to request ID authentication operation. Once the ID authentication is approved, the user end may transmit data in the network. Thereby it can ensure that users connecting to the network through the network connection apparatus for data transmission has been authorized, and data pilferage may be prevented.

The user identification card 10 has storage function. It also has inherent encryption software. Hence company confidential data such as certificates, preshare keys, employee account numbers, passwords or personal network and the like may be stored in the user identification card 10. When an user wants to read the confidential data stored in the user identification card 10 by connecting to an external connection device 121 (such as a modem) or an internal connection device 122 (such as an intranet connection port) of the transmission device 12, the user identification card 10 will send back a data packet to confirm whether the user end is permitted to read the confidential data stored in the user identification card 10. In the event that times of input error signals exceed the presetting of the user identification card 10, the user identification card 10 activates a protection function to block all the paths that attempt to read the internal data and stop any user ends from reading the confidential data to accomplish protection function. Moreover, at present, data stored in the user identification card 10 cannot be copied. Thus data pilferage or disclosure may be prevented. The internal connection device 122 is a network connection port which may be coupled with a switch hub 16 to provide a plurality of network connection ports to link more user ends to form a LAN or WAN network to connect to the network connection apparatus 1. Or the network connection apparatus 1 may be coupled with a wireless interface device 17 and a signal transmitter 18 to link user ends of the internal network 15 to avoid the trouble of establishing network wiring layout.

In addition, in the event that the basic settings of the memory device 11 already include encryption software, it may be coupled with the user identification card 10 to form a double protection function. While implementation requires an extra procedure and becomes more complicated, it can enhance security of network data and is an improvement.

In summary, the invention provides the following features:
1. The network connection apparatus cannot be activated unless receiving an user identification card. Without the user identification card, users cannot access the network to transfer data. External hackers cannot invade the LAN to steal data. Thus security may be enhanced.
2. User identification card has authentication function. It can request to input password. One or more errors occurred during password entering will trigger locking and invalidating of the user identification card. Thus pilferage may be prevented to improve security.
3. User identification card has inherent encryption function. When users want to read or store private and confidential data in the user identification card, authorization for the user identification card has to be obtained first. Thus data protection may be enhanced.
4. User identification card can store main setting data in advance to enable users to access VPN by inserting the user identification card into the network connection apparatus. Therefore complicated setting done by professionals may be dispensed with.

As previously discussed, the invention provides an improved network connection apparatus which not only can enhance data security, also can prevent company internal data from being stolen or disclosed. It also does not need complicated setting as the conventional techniques do. Hence it offers significant improvements over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A network connection apparatus, comprising:
an user identification card for activating the network connection apparatus;
a memory device for storing basic setting data related to the network connection apparatus;
a transmission device to provide data output or input functions for external networks and internal networks; and
a central processor electrically connecting to the user identification card, the memory device and the transmission device and processing data stored in the user identification card, the memory device and the transmission device.

2. The network connection apparatus of claim 1, wherein the network connection apparatus is a router.

3. The network connection apparatus of claim 1, wherein the user identification card is a subscriber identity module (SIM) card which provides identity authentication and encryption functions.

4. The network connection apparatus of claim 1, wherein the memory device is a Flash read only memory.

5. The network connection apparatus of claim 1, wherein the memory device is a Compact Flash card.

6. The network connection apparatus of claim 1, wherein the transmission device includes an external connection device and an internal connection device.

7. The network connection apparatus of claim 6, wherein the external connection device is a modem for linking the external networks.

8. The network connection apparatus of claim 6, wherein the internal connection device is a network connection port for linking the internal networks.

9. The network connection apparatus of claim 8, wherein the internal connection device is coupled with a switch hub to connect a plurality of network connection ports.

10. The network connection apparatus of claim 6, wherein the internal connection device is a wireless interface device for linking the internal networks in a wireless transmission fashion.

11. The network connection apparatus of claim 1, wherein the external networks are the Internet.

12. The network connection apparatus of claim 1, wherein the internal networks are Local Area Networks (LAN).

13. The network connection apparatus of claim 1, wherein the internal networks are Wide Area Networks (WAN).
